(19) United States
(12) Patent Application Publication
(10) Pub. No.: US 2024/0351496 A1
(43) Pub. Date: Oct. 24, 2024

(54) CAR AUXILIARY HEADREST

(71) Applicant: SHEN ZHEN STAND BY ME TECHNOLOGY LIMITED, Shenzhen (CN)

(72) Inventor: ZHIPING ZHOU, Huizhou (CN)

(21) Appl. No.: 18/318,433

(22) Filed: May 16, 2023

(30) Foreign Application Priority Data
Apr. 24, 2023 (CN) 2023209586889

(51) Int. Cl. B60N 2/882; B60N 2/879

(52) U.S. Cl. CPC B60N 2/882; B60N 2/879

(57) ABSTRACT

A car auxiliary headrest is applied to an integrated car seat with a hole, the car auxiliary headrest includes a headrest structure located on a head of a backrest of a car seat, a connecting component passing through the car seat, and a limiting component located on a back of the backrest of the car seat. The connecting component passes through the hole of the car seat to connect the headrest structure and the limiting component together. The connecting component and the limiting component matched with the hole of the car seat are attached to the hole. The car auxiliary headrest fully fits with the hole of the car seat, meets fixation demands of a headrest, solves a problem that an auxiliary headrest has a poor stability caused by clamping at two ends, and provides better driving experiences for drivers and passengers.

### TECHNICAL FIELD

The disclosure belongs to a technical field of car headrests, in particular to a car auxiliary headrest.

### BACKGROUND

With an improvement of living standards, passengers of car seats have put forward more demands for comfort and safety performance of their car seats, and a car auxiliary headrest has emerged to meet the demands of the passengers. With a rise of new energy cars, a traditional split structure of the car seat is gradually replaced by an integrated structure of the car seat with a hole.

In the related art, a traditional car seat auxiliary headrest with bolt fixation is still used for the integrated structure of the car seat with the hole. The traditional car seat auxiliary headrest has a simple structure and only relies on a bolt to pass through the hole of the integrated structure of the car seat, and it uses the clamping force on two sides to achieve fixation. A stability of the traditional car seat auxiliary headrest during use is poor, which affects driving experiences of drivers and passengers during the use.

### SUMMARY

The disclosure provides a car auxiliary headrest, aiming to solve problems that the auxiliary headrest, which is matched with an integrated car seat with a hole, has a poor stability caused by clamping two ends to fix, and affects the driving experiences of drivers and passengers during use.

The disclosure provides the car auxiliary headrest, applied to an integrated car seat with a hole, the car auxiliary headrest includes:
a headrest structure located on a head of a backrest of a car seat,
a connecting component passing through the car seat, and
a limiting component located on a back of the backrest of the car seat; and
the connecting component passes through the hole of the car seat to connect the headrest structure and the limiting component together; the connecting component and the limiting component matched with the hole of the car seat are attached to the hole of the car seat.

In an embodiment, the connecting component includes:
a connecting plate snap-connected to the headrest structure, and a connecting rod connected to the limiting component; and
the connecting plate is fixedly connected to the connecting rod, and an end face of the connecting plate facing away from the headrest structure is an arc-shaped structure, which is matched with the hole of the car seat.

In an embodiment, the limiting component includes:
a panel located on the back of the backrest of the car seat,
a fixed plate fixed with the connecting rod through bolts, and
a support platform located between the panel and the fixed plate; and
the support platform includes bracket components rotatably connected to the fixed plate, a connecting seat, and an external auxiliary support platform located on the connecting seat.

In an embodiment, the limiting component includes:
a fixed plate fixed with the connecting rod through bolts, and
a tissue box located on a side of the fixed plate facing away from the connecting rod.

In an embodiment, a contact surface of the fixed plate in contact with the car seat is an arc-shaped structure matched with the hole of the car seat.

In an embodiment, an end face of the connecting rod close to the limiting component is defined with screw holes, and the fixed plate is fixed with the connecting rod by assembling the bolts into the screw holes.

In an embodiment, a rectangular groove is located in a middle of the panel, and the fixed plate is capable of connecting outside by the rectangular groove penetrating the panel.

In an embodiment, the external auxiliary support platform is located in the rectangular groove, and the external auxiliary support platform is rotatably connected to the connecting seat located on the fixed plate.

In an embodiment, the connecting seat includes:
a base rotatably connected to the fixed plate, and
a rotating plate rotatably connected to a top of the base; and
a center of the rotating plate is provided with a slot hole, and the external auxiliary support platform is movably assembled inside the slot hole.

In an embodiment, two ends of the rectangular groove are respectively provided with strip-shaped slot holes, which pass through the panel.

In an embodiment, the bracket components are exposed to the outside through the strip-shaped slot holes for deflection.

Compared with the related art, the embodiment of the disclosure mainly has the three beneficial effects as follows.

1. The car auxiliary headrest provided by the disclosure meets fixation demands of a headrest, through the connecting component passing through the hole of the car seat to connect the headrest structure and the limiting component together.

2. The car auxiliary headrest provided by the disclosure completes the assembly with the car seat by combining the fixed plate and the connecting plate with the connecting rod, and with the help of the curved surface on the fixed plate and connecting plate, the auxiliary headrest is fully fits with the hole of the car seat, the car auxiliary headrest effectively improves a connectivity with the car seat, improves a stability of drivers and passengers during use, and brings better driving experiences.

3. The support platform in the car auxiliary headrest provided by the disclosure bears the support and fixation role of electronic devices. The bracket component forms a triangular inclined plane support with the car seat, serving as an independent tilted platform. The external auxiliary support platform connected to the connecting seat can serve as a multi-functional support platform to meet more user's demands and provide high-quality electronic device support platform for rear passengers.

### BRIEF DESCRIPTION OF DRAWINGS

FIG. 1 is a structural schematic diagram of a car auxiliary headrest provided by the disclosure.

FIG. 2 is a structural schematic diagram of an integrated car seat with a hole for the car auxiliary headrest provided by the disclosure.

FIG. 3 is a structural schematic diagram of a headrest structure of the car auxiliary headrest provided by the disclosure.

FIG. 4 is a structural schematic diagram of a connecting component and a limiting component of the car auxiliary headrest provided by the disclosure.

FIG. 5 is a structural schematic diagram of the limiting component of the car auxiliary headrest provided by the disclosure.

FIG. 6 is a structural schematic diagram of the connecting component of the car auxiliary headrest provided by the disclosure.

FIG. 7 is a structural schematic diagram of a panel of the car auxiliary headrest provided by the disclosure.

FIG. 8 is a structural schematic diagram of an external auxiliary support platform for the car auxiliary headrest provided by the disclosure after leaving a rectangular groove.

FIG. 9 is a structural schematic diagram of a tissue box for the car auxiliary headrest provided by the disclosure.

FIG. 10 is a structural schematic diagram of a push plate in the tissue box for the car auxiliary headrest provided by the disclosure.

### DETAILED DESCRIPTION OF EMBODIMENTS

Unless otherwise defined, all technologies and scientific terms used in the disclosure have the same meanings as those commonly understood by those skilled in the art. Terms used in specification of the disclosure are only for a purpose of describing embodiments, rather than limiting the disclosure. Terms “including” and “having” in the specification and claims and drawings of the disclosure, and any variations of the terms, are intended to cover non-exclusive inclusion. Terms “first”, “second”, etc. in the specification, the claims and the drawings of the disclosure are used to distinguish different objects, rather than to describe a specific order.

The reference to “embodiments” in the disclosure means that specific features, structures, or characteristics described in conjunction with the embodiments can be included in at least one embodiment of the disclosure. The appearance of “embodiments” in various positions in the specification does not necessarily refer to the same embodiment, nor is it mutually exclusive with other embodiments, but rather independent or alternative embodiments. Those skilled in the art explicitly and implicitly understand that the embodiments can be combined with other embodiments.

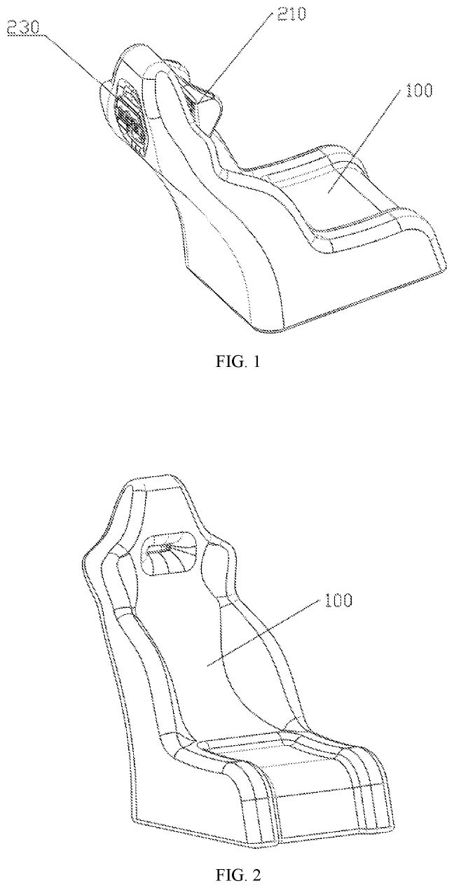

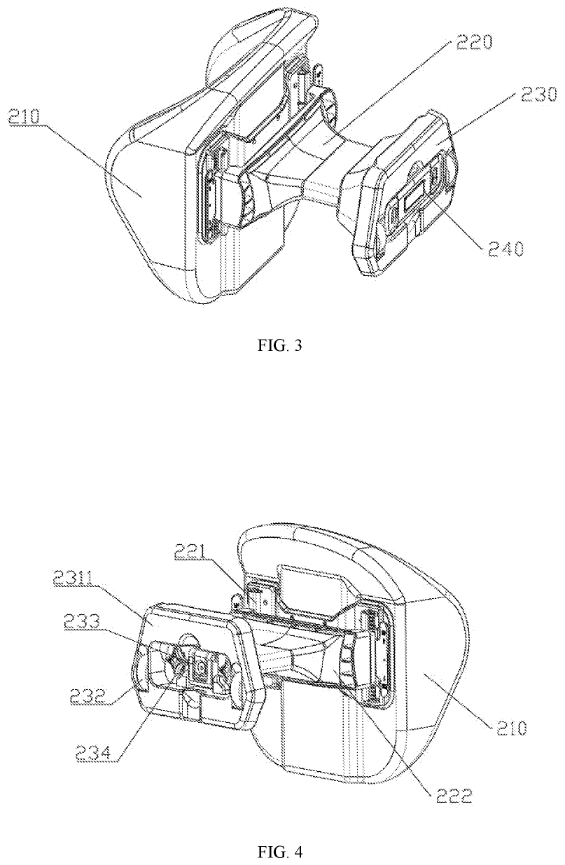

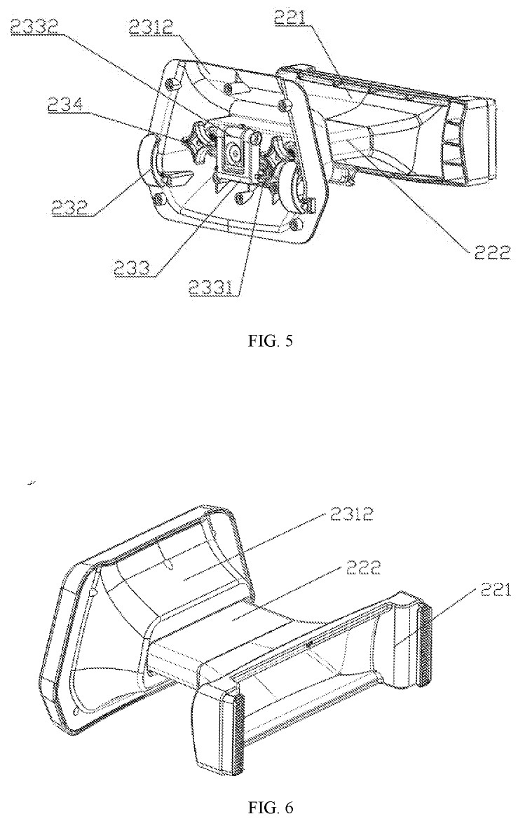

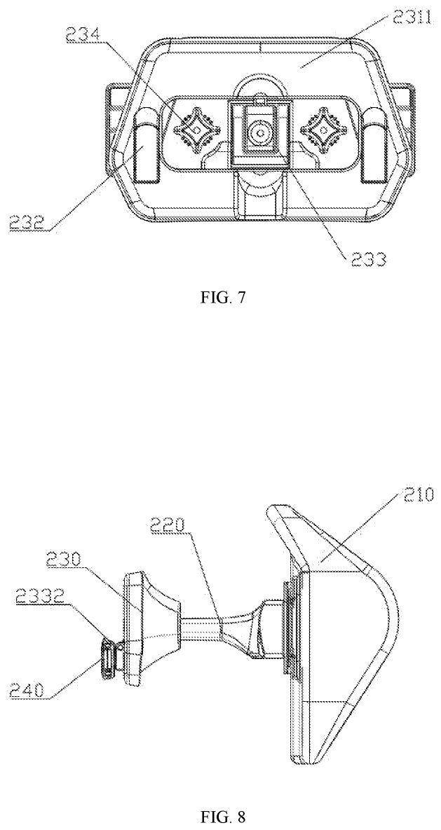

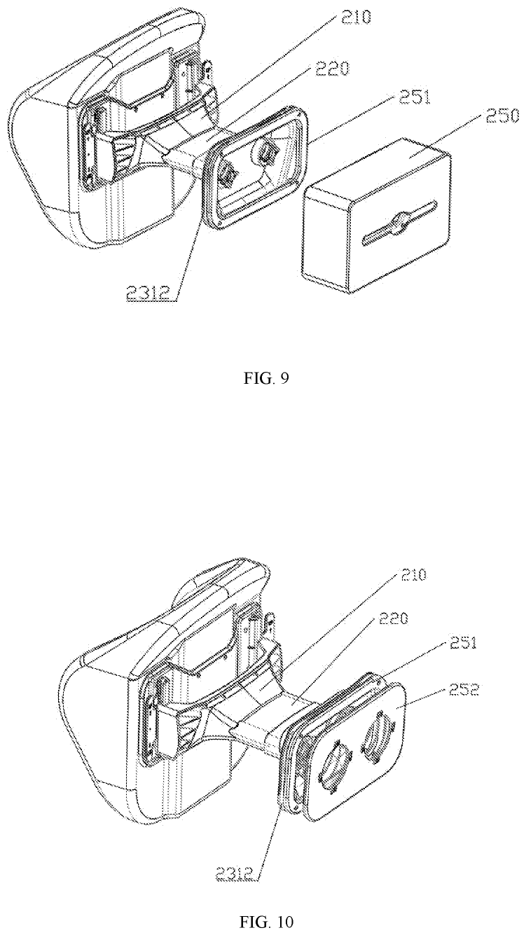

In an embodiment, the disclosure provides a car auxiliary headrest, as shown in FIGS. 1˜8. The car auxiliary headrest is applied to a car seat 100, and the car auxiliary headrest includes:
a headrest structure 210 located on a head of a backrest of the car seat 100,
a connecting component 220 passing through the car seat 100, and
a limiting component 230 located on a back of the backrest of the car seat 100.

The connecting component 220 passes through a hole on the car seat 100 to connect the headrest structure 210 with the limiting component 230, the connecting component 220 and the limiting component 230 matched with the hole on the car seat 100 are attached to the car seat 100, effectively improving a stability during use and enhancing driving experiences of drivers and passengers during the use.

In an embodiment, as shown in FIG. 2, the car seat 100 is a new type of integrated car seat that adopts integrated molding technology. A connecting rod mode is no longer used for support between the head and a back of the car seat 100, and a full surround mode is adopted, the hole that passes through the car seat 100 is only set at a connection position.

The connection component 220 includes:
a connecting plate 221 snap-connected to the headrest structure 210, and
a connecting rod 222 connected to the limiting component 230.

The connecting plate 221 is fixedly connected to the connecting rod 222, and an end face of the connecting plate 221 facing away from the headrest structure 210 is an arc-shaped structure, which is convenient for matching with the hole of the car seat 100 and improves the stability during a connection process

In an embodiment, the limiting component 230 includes:
a panel 2311 located on the back of the backrest of the car seat 100,
a fixed plate 2312 fixed with the connecting rod 222 through bolts, and
a support platform located between the panel 2311 and the fixed plate 2312.

The support platform includes bracket components 232, a connecting seat 233, and an external auxiliary support platform 240 located on the connecting seat 233.

In an embodiment, the connecting plate 221 and the connecting rod 222 are made using the integrated molding technology. A side of the connecting plate 221 close to headrest structure 210 is provided with snap plates, which are connected to the headrest structure 210 in a snap-connection manner. The headrest structure 210 is the related art, and the snap connection technology between the headrest structure 210 and the connecting plate 221 is the related art too. The headrest structure 210 and the connecting plate 221 mainly rely on the mutual meshing and fixed connection between different snaps. An end face of the connecting rod 222 close to the limiting component 230 is provided with screw holes.

A surface of the fixed plate 2312 is fixedly connected to the panel 2311 through the bolts, and another surface is in contact with the hole of the car seat 100. Limiting bolts 234 located in the fixed plate 2312 are assembled into the screw holes of the connecting rod 222 to fix the fixed plate 2312. The plane where the fixed plate 2312 contacts with the car seat 100 is curved, making it easy for the car seat 100 to match with the fixed plate 2312. The fixed plate 2312 and the connecting plate 221 are combined with the connecting rod 222 to complete the assembly of the car seat 100, and with the help of the curved surface of the fixed plate 2312 and the connecting plate 221, the car auxiliary headrest fully fits with the hole of the car seat 100, which effectively improves connectivity with the car seat 100, improves a stability of the driver and passenger during use, and brings a better driving experience.

The support platform bears the support and fixation role of electronic devices, forming a triangular inclined plane support between the bracket components 232 and the car seat 100 as an independent tilted platform. The external auxiliary support platform 240 connected to the connecting seat 233 can serve as a multi-functional support platform to meet more user's demands and provide high-quality support platforms for rear passengers.

In an embodiment, the panel 2311 is provided with a rectangular groove in a middle, and the external auxiliary support platform 240 is located inside the rectangular groove. The rectangular groove passes through the panel 2311 to connect the fixed plate 2312 with outside. The external auxiliary support platform 240 is rotatably connected to the connecting seat 233 disposed on the fixed plate 2312. The limiting bolts 234 are distributed on two sides of the connecting seat 233 and the limiting bolts 234 are located on the external auxiliary support platform 240.

In an embodiment, when assembling the car seat 100 and the car auxiliary headrest, the connecting rod 222 passes through the hole of the car seat 100, and then the external auxiliary support platform 240 is detached from the rectangular groove. The limiting bolts 234 are located into the screw holes of the connecting rod 222 through the fixed plate 2312, completing the fixation of the fixed plate 2312 and the connecting rod 222, after completing the fixation, storing the external auxiliary support platform 240 back into the rectangular groove.

In an embodiment, the connecting seat 233 includes:
a base 2331 rotatably connected to the fixed plate 2312, and
a rotating plate 2332 rotatably connected to a top of the base 2331.

The center of the rotating plate 2332 is provided with a slot hole, and the external auxiliary support platform 240 is movably assembled in the slot hole.

In an embodiment, the external auxiliary support platform 240 is a rectangular structure, which is a mobile phone bracket structure adopted by the related art. The external auxiliary support platform 240 moves in a circular motion around the slot hole at the center of the rotating plate 2332, while the base 2331 connected to the fixed plate 2312 can rotate to form a 90° angle with the fixed plate 2312 and leave the rectangular groove. At the same time, the rotating plate 2332 is rotated to ensure that the rotating plate 2332 and the fixed plate 2312 are always in a parallel state, the connecting seat 233 is mainly used to support the external auxiliary support platform 240. When rotation is needed, the connecting seat 233 can be adjusted to make the external auxiliary support platform 240 detach from the rectangular groove, facilitating the rotation adjustment action of the external auxiliary support platform 240.

In an embodiment, two ends of the rectangular groove are respectively provided with strip-shaped slot holes, which pass through the panel 2311. The bracket components 232 rotatably connected to the fixed plate 2312 are exposed externally through the slot holes, and the bracket components 232 are rotated to leave the slot holes, forming a 90° angle between the bracket components 232 and the limiting component 230. Two bracket components 232 form a flat surface that cooperates with one of the limiting component 230 and the car seat 100 to form a tilted device placement platform, facilitating placements of mobile phones or tablets.

In an embodiment, the limiting component 230 includes:
a fixed plate 2312 fixed with the connecting rod 222 through bolts, and
a tissue box 250 located on a side of the fixed plate 2312 facing away from the connecting rod 222.

In an embodiment, an end face of the tissue box 250 facing away from the fixed plate 2312 is a movable structure that can be lifted to store items. The connection structure between the tissue box 250 and the fixed plate 2312 includes but is not limited to following connection methods: an end face of the fixed plate 2312 close to the tissue box 250 is provided with a connection frame 251, an outer edge of the connection frame 251 is provided with a groove, and a side of the tissue box 250 close to the connection frame 251 is an open structure; the tissue box 250 is nested and assembled on the connection frame 251, and the structure and connection relationship between the tissue box 250 and the connection frame 251 can be achieved using the related art.

In an embodiment, the tissue box 250 is further internally provided with a push plate 252, which is elastically connected to the fixed plate 2312 through a spring. The push plate 252 can help push the tissue box for an easy access.

It should be noted that for the sake of a simple description, the embodiments are all expressed as a series of action combinations. However, those skilled in the art should be aware that the disclosure is not limited by a sequence of actions. As according to the disclosure, certain steps may be performed in other sequences or simultaneously. Secondly, those skilled in the art should further be aware that the embodiments described in the specification are all preferred embodiments, and the actions and modules involved may not be necessary for the disclosure.

The above embodiments are only used to illustrate the technical solution of the disclosure, not to limit a scope of protection of the disclosure. Apparently, the embodiments are only some of the embodiments of the disclosure, not all embodiments. Based on the embodiments, all other embodiments obtained by those skilled in the art without creative labor fall within the scope of protection of the disclosure. Although the disclosure has been described in detail with reference to the above embodiments, those skilled in the art can still combine, add, delete, or make other adjustments to features in each the embodiment of the disclosure according to situations without conflicts and creative labors, in order to obtain other technical solutions that are not fundamentally separate from the concept of the disclosure, these technical solutions further belong to the scope of protection required by the disclosure.

What is claimed is:

1. A car auxiliary headrest, applied to an integrated car seat with a hole, wherein the car auxiliary headrest comprises:
a headrest structure located on a head of a backrest of a car seat,
a connecting component passing through the car seat,
a limiting component located on a back of the backrest of the car seat; and
wherein the connecting component passes through the hole of the car seat to connect the headrest structure and the limiting component together; the connecting component and the limiting component matched with the hole of the car seat are attached to the hole of the car seat.

2. The car auxiliary headrest according to claim 1, wherein the connecting component comprises:
a connecting plate snap-connected to the headrest structure, and
a connecting rod connected to the limiting component; and
wherein the connecting plate is fixedly connected to the connecting rod, and an end face of the connecting plate facing away from the headrest structure is an arc-shaped structure, which is matched with the hole of the car seat.

3. The car auxiliary headrest according to claim 2, wherein the limiting component comprises:
a panel located on the back of the backrest of the car seat,
a fixed plate fixed with the connecting rod through bolts, and
a support platform located between the panel and the fixed plate; and
wherein the support platform comprises: bracket components rotatably connected to the fixed plate, a connecting seat, and an external auxiliary support platform located on the connecting seat.

4. The car auxiliary headrest according to claim 2, wherein the limiting component comprises:
a fixed plate fixed with the connecting rod through bolts, and
a tissue box located on a side of the fixed plate facing away from the connecting rod.

5. The car auxiliary headrest according to claim 3, wherein a contact surface of the fixed plate in contact with the car seat is an arc-shaped structure matched with the hole of the car seat.

6. The car auxiliary headrest according to claim 5, wherein an end face of the connecting rod close to the limiting component is defined with screw holes, and the fixed plate is fixed with the connecting rod by assembling the bolts into the screw holes.

7. The car auxiliary headrest according to claim 3, wherein a rectangular groove is located in a middle of the panel, and the fixed plate is capable of connecting outside by the rectangular groove penetrating the panel.

8. The car auxiliary headrest according to claim 7, wherein the external auxiliary support platform is located in the rectangular groove, and the external auxiliary support platform is rotatably connected to the connecting seat located on the fixed plate.

9. The car auxiliary headrest according to claim 8, wherein the connecting seat comprises:
a base rotatably connected to the fixed plate, and
a rotating plate rotatably connected to a top of the base; and
wherein a center of the rotating plate is provided with a slot hole, and the external auxiliary support platform is movably assembled inside the slot hole.

10. The car auxiliary headrest according to claim 9, wherein two ends of the rectangular groove are respectively provided with strip-shaped slot holes, which pass through the panel, and the bracket components are deflected through the strip-shaped slot holes.

11. The car auxiliary headrest according to claim 4, wherein the limiting component further comprises: a push plate elastically connected to the fixed plate and disposed in the tissue box.

12. The car auxiliary headrest according to claim 4, wherein the limiting component further comprises: a connection frame disposed between the fixed plate and the tissue box; an outer edge of the connection frame is provided with a groove connected with an opening structure of the tissue box.

13. The car auxiliary headrest according to claim 4, wherein the tissue box comprises: a movable structure located on a side of the tissue box facing away from the fixed plate, and configured to be lifted to store items in the tissue box.

14. A car auxiliary headrest, comprising:
a connecting component, configured to pass through a hole of a car seat;
a headrest structure, detachably connected with a side of the connecting component;
wherein the headrest structure is configured to support a head of a user sitting on the car seat; and
a limiting component, detachably connected with another side of the connecting component; wherein the limiting component is configured to place an object.

15. The car auxiliary headrest according to claim 14, wherein the object is one of an electronic device and a tissue.

16. The car auxiliary headrest according to claim 14, wherein the connecting component comprises:
a connecting plate, snap-connected to the headrest structure, and
a connecting rod, connected between the limiting component and the connecting plate; and
wherein an end face of the connecting plate facing away from the headrest structure is an arc-shaped structure configured to be matched with the hole of the car seat, and a side of the connecting plate close to the headrest structure is provided with snap plates snapped to the headrest structure.

17. The car auxiliary headrest according to claim 16, wherein the limiting component comprises:
a fixed plate, fixedly connected with the connecting rod;
a panel, located on the fixed plate;
a support platform, located between the panel and the fixed plate, and comprising:
bracket components, rotatably connected to the fixed plate;
a connecting seat, rotatably connected to the fixed plate; and
an auxiliary support platform, located on the connecting seat.

18. The car auxiliary headrest according to claim 16, wherein the limiting component comprises:
a fixed plate, fixedly connected with the connecting rod;
a tissue box, located on a side of the fixed plate facing away from the connecting rod; and
a push plate, elastically connected to the fixed plate and disposed in the tissue box.
